(19) United States
(12) Patent Application Publication
(10) Pub. No.: US 2011/0131492 A1
(43) Pub. Date: Jun. 2, 2011

(54) Audio-visual multimedia transmitting/editing device

(76) Inventor: Ching-Yao Chen, Chung Ho City (TW)

(21) Appl. No.: 12/591,664

(22) Filed: Nov. 27, 2009

(51) Int. Cl. G06F 3/048; G06F 15/16

(52) U.S. Cl. 715/716; 715/738

(57) ABSTRACT

An audio-visual multimedia transmitting/editing device is internally provided with a control circuit, which includes a CPU, a system control unit, a multimedia processing unit, a standard system I/O unit, a human interface, a memory controller, a network transmission unit and a register bus controller; and supports an audio/video editing and online transmitting application program. When the audio-visual multimedia transmitting/editing device is connected to an Internet-connectable computer or mobile phone having the above application program installed thereon, the register bus controller and the application program mutually identify one another's identification code. When the identification codes match each other, the application program is automatically initialized to grab desired audio/video files stored in the memory controller for playing or editing; or uploading the edited audio/video files for sharing with other users over the Internet or emails; or downloading flash video from the Internet for storing on the memory controller.

### FIELD OF THE INVENTION

The present invention relates to an audio-visual multimedia transmitting/editing device, and more particularly to a device that supports an application program which is automatically initialized when matching an identification code of the device, in order to provide combined functions of connecting to the Internet to grab, play and edit audio/video data and download flash video.

### BACKGROUND OF THE INVENTION

Generally, a digital camera and an MP4 player are two independent and separate devices. When it is desired to upload or download audio or visual data, a user has to use different application programs to perform different data playing, editing, and network transmission functions on the two devices. And, to download the flash video from the Internet, the user has to use another file conversion software program installed in a computer. Therefore, complicated operating procedures are involved in uploading and downloading audio, visual, and multimedia data to bring a lot of inconveniences to the user. It is therefore tried by the inventor to develop an audio-visual multimedia transmitting/editing device for a user to conveniently upload or download audio/video data to or from the Internet for sharing or storing.

### SUMMARY OF THE INVENTION

A primary object of the present invention is to provide an audio-visual multimedia transmitting/editing device which can be connected to an Internet-connectable computer or mobile phone having an audio/video editing and online transmitting application program installed thereon. A register bus controller of the audio-visual multimedia transmitting/editing device and the audio/video editing and online transmitting application program mutually identify one another's identification code so as to automatically initialize the application program to grab audio/video files stored on the audio-visual multimedia transmitting/editing device for playing and editing, or for uploading to the Internet for sharing the audio/video files with other users over the Internet or emails. The audio-visual multimedia transmitting/editing device can also be connected to the Internet to download flash video for storing thereon.

To achieve the above and other objects, the audio-visual multimedia transmitting/editing device of the present invention includes a main body, which is internally provided with a control circuit for processing, storing and playing audio/video data, and the control circuit includes a microprocessor or central processing unit (CPU), a network transmission unit, a human interface, a multimedia processing unit, and a register bus controller. By operating the audio-visual multimedia transmitting/editing device, different functions, such as taking or shooting pictures, recording music, listening to radio, etc., all can be performed. The register bus controller and the audio/video editing and online transmitting application program installed on an Internet-connectable computer or a mobile phone mutually identify one another's identification code so as to automatically initialize the application program.

The audio/video editing and online transmitting application program allows a user to play and edit the audio/video files stored on the audio-visual multimedia transmitting/editing device, and to directly upload the desired audio/video files to the Internet for sharing with other users or download flash video from the Internet for storing on the audio-visual multimedia transmitting/editing device. Therefore, combined and useful functions of editing, online transmitting and downloading audio/video multimedia are provided.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front perspective view of an audio-visual multimedia transmitting/editing device according to the present invention;

FIG. 2 is a rear perspective view of the audio-visual multimedia transmitting/editing device of FIG. 1;

FIG. 3 is a block diagram showing a preferred embodiment of a control circuit for the audio-visual multimedia transmitting/editing device of the present invention; and

FIG. 4 is a block diagram showing the operation of a register bus controller included in the audio-visual multimedia transmitting/editing device of the present invention.

### DETAILED DESCRIPTION OF THE PREFERRED EMBODIMENTS

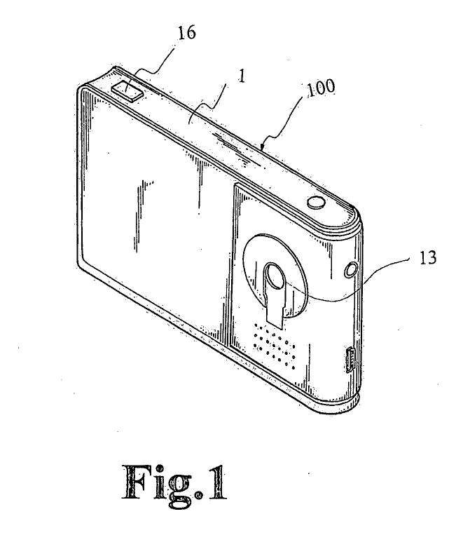

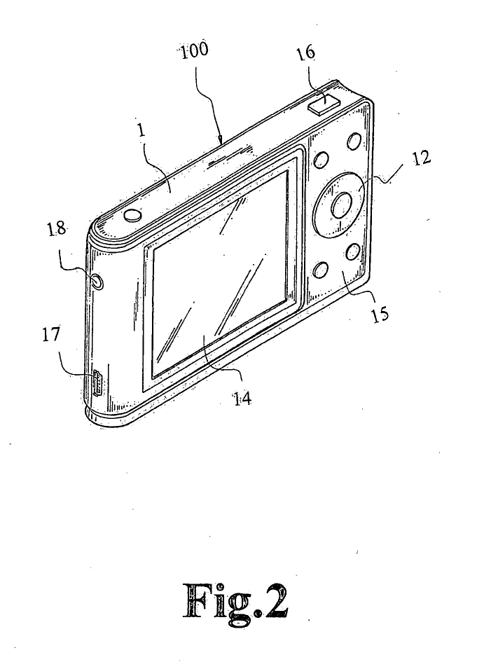

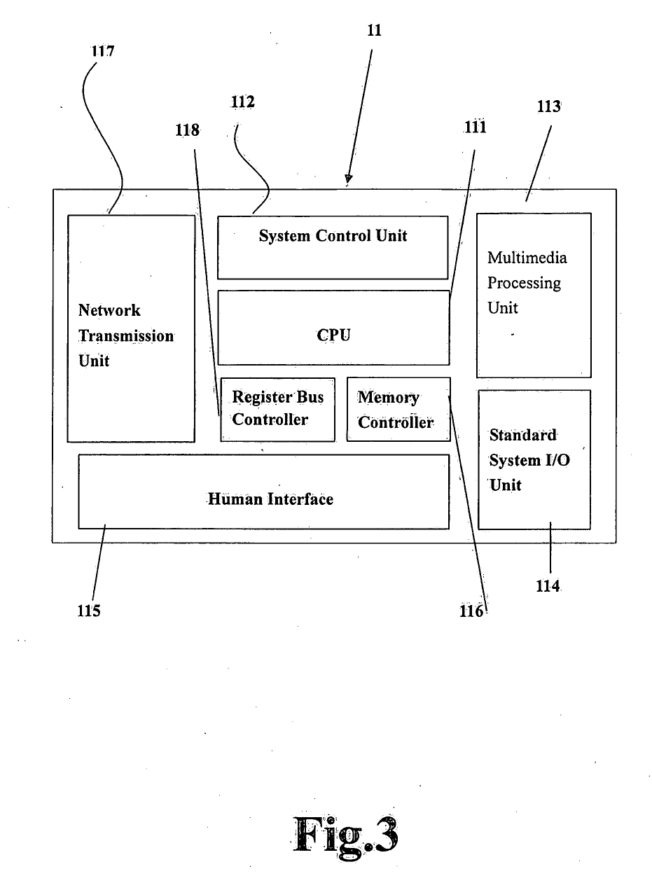

Please refer to FIGS. 1 and 2 that are front and rear perspective views, respectively, of an audio-visual multimedia transmitting/editing device 100 according to an embodiment of the present invention; and to FIG. 3 that is a block diagram showing a preferred embodiment of a control circuit 11 for the audio-visual multimedia transmitting/editing device 100. As shown, the audio-visual multimedia transmitting/editing device 100 includes a main body 1, a plurality of operation keys 12 and input/output (I/O) connectors, a micro camera lens 13, and a liquid crystal display (LCD) 14. The operation keys 12 are arranged on a control panel 15 located at a rear face of the main body 1. A shutter release button 16 is provided on a top of the main body 1. A universal serial bus (USB) socket 17 and an earphone jack 18 are provided on one side of the main body 1. The control circuit 11 for the audio-visual multimedia transmitting/editing device 100 includes a microprocessor or central processing unit (CPU) 111 for executing a predetermined audio/video editing and online transmitting application program to process audio/video data; a system control unit 112 for driving the CPU 111 to work; a multimedia processing unit 113 for processing audio/video and image data; a standard system I/O unit 114 for receiving and outputting data; a human interface 115 connected to the LCD 14 and the micro camera lens 13 and connectable to an external earphone for receiving audio/video data, transferring the received audio/video data to the CPU 111, and transferring data from the CPU 111 for outputting; a memory controller 116 for storing data therein; a network transmission unit 117 for transmitting audio/video data over a network; and a register bus controller 118 for identifying and automatically initializing the audio/video editing and online transmitting application program.

The audio-visual multimedia transmitting/editing device 100 with the above structure can be operated to play music, listen to radio, or record sound, or be switched to a camera mode and then operate the micro camera lens 13 and the shutter release button 16 to shoot or take pictures. Images of pictures taken can be stored in the memory controller 116, and the stored images can be played back on the LCD 14.

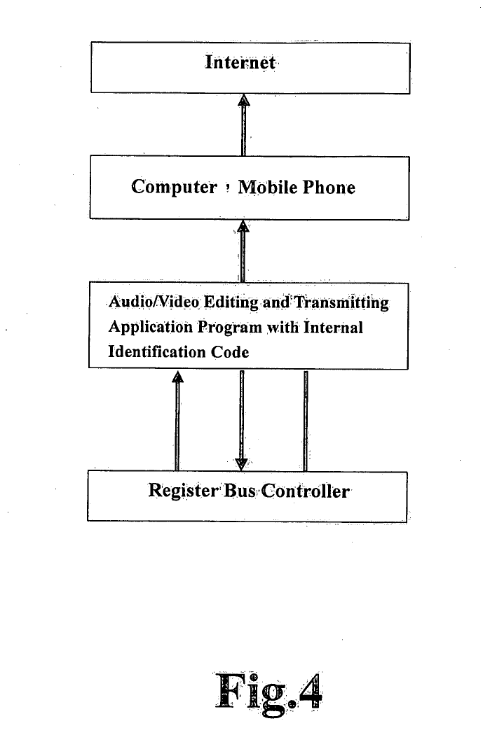

The audio-visual multimedia transmitting/editing device 100 supports an audio/video editing and online transmitting application program that is installed on an Internet-connectable computer or a mobile phone and capable of downloading flash video from the Internet for storing on the device 100. Please refer to FIG. 4. When the audio-visual multimedia transmitting/editing device 100 is connected to an Internet-connectable computer or a mobile phone having the above-mentioned audio/video editing and online transmitting application program installed thereon, the register bus controller 118 of the audio-visual multimedia transmitting/editing device 100 and the application program mutually identify one another's identification code. When the identification codes match each other, the audio/video editing and online transmitting application program is automatically initialized to grab audio/video files stored in the memory controller 116 of the audio-visual multimedia transmitting/editing device 100 for playing and/or editing these files, or directly transmits these files via the network transmission unit 117 for sharing them with other network users on a website, such as YouTube, or in emails, or links to the Internet to directly download flash video therefrom for storing on the device 100. For example, a user of the audio-visual multimedia transmitting/editing device 100 can use the network transmission unit 117 and the audio/video editing and online transmitting application program to upload a file stored on the audio-visual multimedia transmitting/editing device 100 to the website of YouTube to share the file with other users. Similarly, the user of the audio-visual multimedia transmitting/editing device 100 can also download audio/video files that are uploaded to YouTube by other users and store the downloaded audio/video files in the flv file format. Therefore, the audio-visual multimedia transmitting/editing device 100 can provide the user with combined functions of editing and online transmitting multimedia audio-visual multimedia data.

As can be seen from FIG. 2, the audio-visual multimedia transmitting/editing device 100 is provided with a USB socket 17 and an earphone jack 18. A USB flash disk (not shown) can be externally connected to the USB socket 17, so that data on the flash disk can be input to and stored in the memory controller 116, giving the audio-visual multimedia transmitting/editing device 100 increased value of application. An earphone (not shown) can be externally connected to the earphone jack 18, so that a user can listen to music files stored in the memory controller 116, radio programs, or music videos.

In brief, the audio-visual multimedia transmitting/editing device of the present invention can integrate audio/video data and automatically initialize an audio/video editing and online transmitting application program run on a computer, allowing a user to conveniently enjoy the functions of taking pictures, recording music, editing audio/video files, transmitting audio/video files over network to share the files with other users.

The control circuit of the audio-visual multimedia transmitting/editing device of the present invention cooperates with the audio/video editing and online transmitting application program run on a computer to allow grabbing, editing, and playing audio/video files stored on the audio-visual multimedia transmitting/editing device, and transmitting the audio/video files over a network. Therefore, the audio-visual multimedia transmitting/editing device of the present invention is more valuable and practical for use.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An audio-visual multimedia transmitting/editing device, comprising:
a main body having a micro camera lens, an LCD, a plurality of operation keys, and a plurality of connection sockets provided thereon; and
a control circuit including a microprocessor (CPU) for executing a predetermined audio/video editing and online transmitting application program; a system control unit for driving the CPU to work; a multimedia processing unit for processing audio/video and image data; a standard system I/O unit for receiving and outputting data; an human interface connected to the LCD and the micro camera lens and connectable to an external earphone for receiving audio/video data, transferring the received audio/video data to the CPU, and transferring data from the CPU for outputting; a memory controller for storing data therein; a network transmission unit for transmitting audio/video data to and from a network; and a register bus controller for initializing the audio/video editing and online transmitting application program;
whereby audio/video files stored in the memory controller can be uploaded to the Internet via the network transmission unit for sharing with other users, and flash video can be downloaded from the Internet for storing in the memory controller; and when the audio-visual multimedia transmitting/editing device is connected to an Internet-connectable computer or a mobile phone having the audio/video editing and online transmitting application program installed thereon, the register bus controller and the audio/video editing and online transmitting application program mutually identify one another's identification code, and when the identification codes match each other, the audio/video editing and online transmitting application program is automatically initialized to grab desired audio/video files stored in the memory controller for playing or editing, or upload the edited audio/video files for sharing with other users over the Internet or emails, or downloading flash video from the Internet for storing on the memory controller.
